(19) United States
(12) Patent Application Publication
(10) Pub. No.: US 2011/0017692 A1
(43) Pub. Date: Jan. 27, 2011

(54) HINGE APPARATUSES, STRUCTURES, AND SYSTEMS FOR STRUCTURALLY RIGID AND DURABLE, FOLDING SUPPORT FURNITURE

(75) Inventors: Anna Martina Marietta, Seattle, WA (US); Jens Niels Thomson, Redmond, WA (US)

Correspondence Address: TUROCY & WATSON, LLP, 127 Public Square, 57th Floor, Key Tower, CLEVELAND, OH, 44114, US

(73) Assignee: SLAM BRANDS, INC., Redmond, WA (US)

(21) Appl. No.: 12/509,270

(22) Filed: Jul. 24, 2009

(51) Int. Cl. A47B 47/00; E05D 5/10; B23P 11/00

(52) U.S. Cl. 211/195; 16/386; 29/428

(57) ABSTRACT

The disclosed subject matter provides hinging apparatuses, structures, and systems for folding support furniture systems, and methods of assembly therefor. The disclosed subject matter advantageously provides structurally rigid connections between component parts of support furniture systems, while allowing for durable support furniture. In various non-limiting embodiments, the provided hinging apparatuses allow for a folding support furniture system to be folded up for convenient and efficient storage and ease of transport. With the hinges extended to their designed extension point, and when fully assembled, the hinging apparatuses, in conjunction with the disclosed locking mechanisms provide the structural rigidity and load bearing capability necessary to support current and future home entertainment system weight loads, as well as providing numerous advantages for other support furniture markets. Further non-limiting embodiments are provided that illustrate the advantages and flexibility of the disclosed structures.

### FIELD OF THE INVENTION

The disclosed subject matter is directed to support furniture, and more specifically to support furniture and methods for assembly of support furniture that incorporate structures and hinging apparatuses that can facilitate providing structural rigidity and load bearing capability, ease of on-site assembly and disassembly, efficient storage and ease of transport, and durability and improved life over conventional support furniture systems.

### BACKGROUND OF THE INVENTION

Recently, the demand and market for lower cost end-user assembled furniture has risen dramatically. One reason that the market for end-user assembled furnishings has risen is that many of the cost-effective solutions are produced overseas where labor cost advantages can be substantial. However, this creates the need for efficient storage and ease of transport to the end-user destination. This results in a preponderance of designs that are composed of flat panels of medium medium-density fiberboard (MDF) that have to be assembled with hand tools and an array of pins, screws, nails, etc.

The result of the prevalence of these MDF-based designs is that many of these furnishings are an assemble-once on-site proposition that often cannot survive the rigors of disassembly for transportation or transportation intact to a new site. Consequently, these designs can fail to meet many of the market demands by certain consumers in segments of this market.

As an example, consider that a college student's low budget and transitory lifestyle dictates the need for low cost furnishings that are easily assembled on-site. In addition to the above described disadvantages, to date, much of the available options have been in purchasing second-hand furnishings and then reselling these after the user's temporary needs have been met. For instance, at the end of a school year, it is often easier and more cost-effective to resell any furnishings than risk damage in disassembly or in transport of bulky assembled furnishings. As a result, these trends have resulted in a primary and secondary market for somewhat ‘disposable’ furniture. However, such a ‘disposable’ feature can result in further unappealing aspects of conventional assemble on-site furniture that a particular market segment might frown on as a wasteful use of resources or an avoidable side-effect that can be harmful to the environment.

With the advances in the consumer electronics industry (with consequential price improvements), many of these aforementioned consumers are able to afford more substantial electronic appliances such as liquid crystal display (LCD) or plasma televisions or computer monitors. Large screen televisions and computer displays are now commonplace. Thus, many of these consumers desire these types of assemble on-site furniture to not only be easily transportable and assembled and disassembled on-site, but they must also be able to support substantial loads that can cause previous designs to fatigue or sag under the substantial weight loads that are becoming increasingly common.

What is thus desired is structurally rigid and load bearing support furniture systems can facilitate providing ease of on-site assembly and disassembly, efficient storage and ease of transport, and durability and improved life over conventional support furniture systems.

### SUMMARY OF THE INVENTION

In various embodiments, the invention provides hinging apparatuses and structures that can provide support furniture systems that are easily assembled and disassembled with the minimal use of hand tools. The provided systems and support furniture structures are structurally rigid and have relatively high load bearing capability. In addition, the disclosed systems and structures provide for efficient storage and ease of transport, while delivering considerable durability improvements and improved life over conventional support furniture systems.

For improved structural rigidity and load bearing capability, the disclosed subject matter includes one or more structures for locking the hinge apparatuses into the assembled position. For example, various configurations of locking devices can be implemented according to the disclosed subject matter to prevent embodiments of a folding support furniture system from deflecting away from the assembled configuration or folding under load.

For instance, in one non-limiting embodiment, a support furniture system can incorporate an integrated display bracket having a main mounting surface (e.g., a bracket head) for supporting an attached electronic display device, which bracket head can be attached to the support furniture base via a bracket post. Various embodiments of the disclosed hinging apparatus, in conjunction with the disclosed hinge apparatus locking implementations, can provide the necessary structural rigidity to support the load of a display mounted on the disclosed integrated display bracket, without sacrificing the aforementioned storage and transport benefits.

Further non-limiting embodiments of the disclosed subject matter describe methods of assembly of the support furniture systems described herein. Additional features of the disclosed subject matter are described in more detail below.

### BRIEF DESCRIPTION OF THE DRAWINGS

The hinge apparatuses, structures, systems, and methodologies of the disclosed subject matter are further described with reference to the accompanying drawings in which:

FIGS. 1A to 1D illustrate an exemplary non-limiting embodiment of support furniture systems in accordance with aspects of the disclosed subject matter; in which

FIG. 1A illustrates an exploded view of component parts of an exemplary television stand;

FIG. 1B illustrates structural components of the exemplary embodiment in a folded position suitable for compact storage and transport;

FIG. 1C illustrates a range of motion of component parts provided by exemplary non-limiting embodiments of a hinging apparatus during an exemplary assembly process;

FIG. 1D further illustrates the exemplary assembly process for the provided embodiment;

FIGS. 2A to 2C illustrate details of an exemplary non-limiting embodiment of a hinging apparatus in accordance with the disclosed subject matter; in which

FIG. 2A illustrates an exploded view of component parts of an exemplary hinging apparatus;

FIG. 2B illustrates an exploded view of component parts of an exemplary hinging apparatus with a locking tab located proximate to the hinging apparatus;

FIGS. 2C to 2D depict views of an assembled exemplary hinging apparatus with a locking tab located proximate to the hinging apparatus;

FIGS. 3A to 3C illustrate top, front, and side plan views of the exemplary non-limiting television stand shown in FIGS. 1A to 1D;

FIGS. 4A to 4C depict an exemplary non-limiting implementation of a removable integrated display bracket, which, when attached to the exemplary television stand shown in FIGS. 1A to 1D, can capitalize on the strength and durability provided by support furniture systems implemented in accordance with aspects of the disclosed subject matter;

FIGS. 5A to 5D illustrate a further non-limiting implementation of support furniture systems that depict the richness of designs options that can be implemented in accordance with aspects of the disclosed subject matter, in which FIG. 5A illustrates a folded configuration, FIGS. 5B to 5C illustrate further assembly steps of the implementation, FIG. 5D provides a closer detailed illustration of the hinge apparatuses facilitating benefits provided by the implementation;

FIGS. 6A to 6D illustrate a further non-limiting embodiment of a support furniture system (e.g., a computer desk) in accordance with aspects of the disclosed subject matter, in which FIG. 6A illustrates a folded configuration, and FIGS. 6B to 6D illustrate further assembly steps of the implementation; and

FIG. 7 depicts exemplary non-limiting methodologies for assembling a support furniture system or apparatus (e.g., a television stand) in accordance with aspects of the disclosed subject matter.

### DETAILED DESCRIPTION OF ILLUSTRATIVE EMBODIMENTS

### Overview

As described above, conventional assemble on-site furniture has failed to meet consumer expectations of many segments of the market. While some prior art end-user assembled furniture can be compactly stored and shipped, easily assembled, or durable and structurally rigid. In many instances, conventional assemble on-site furniture cannot live up to the rigors of disassembly, transport and reassembly, or transport in fully assembled condition. In some cases, what might be rigid and durable may be too heavy and bulky for efficient storage and ease of transport. In other cases, assemble on-site furniture may be intended to be assembled only once, leaving the user to decide to abandon it, because it might be cheaper to purchase anew rather than cover the costs of storage or transportation. Accordingly, improved furniture utilizing novel hinge apparatuses, structures, and systems is provided by the disclosed subject matter.

In various embodiments, the disclosed support furniture systems provide efficient storage and ease of transport, while delivering improved durability and improved life over conventional support furniture systems. In accordance with the disclosed subject matter, hinging apparatuses and a locking mechanisms are used in conjunction to provide the unique advantages and benefits afforded by the disclosed apparatuses, structures, and systems. Thus, in various embodiments, the subject matter provides support furniture systems that are structurally rigid with high load bearing capability in addition to ease of on-site assembly and disassembly.

In further embodiments, a process is described for assembling a support furniture system (e.g., a television stand) in accordance with aspects of the disclosed subject matter.

As used herein, the terms “hinge,” “hinge apparatus,” “hinging apparatus,” “hinging structure,” “pivot,” “flexible connecting member,” and other terms as suggested by the context are intended to be understood to be a joint that holds two parts together so that one can swing relative to the other. In addition, the use of the terms “temporary,” and “temporarily” such as in the phrase “temporary locking,” “temporarily fastening,” etc. are intended to denote that an action such as “locking,” “fastening,” etc. is performed accordingly so long as it is desired (e.g., a “temporary fastening” would last until a user no longer desired items to be fastened).

Additionally, variations of the disclosed subject matter as suggested by the disclosed structures are intended to be encompassed within the scope of the subject matter disclosed herein. Furthermore, the various embodiments of the furniture designs of the disclosed subject matter include variations in the number, placement, location, angular swing, etc. of the disclosed hinging apparatuses as well as suitable replacements for hinge-like mechanisms (e.g., ball and socket joints, heim joints or spherical rod ends, flexible connecting members such as that fabricated from a polymeric compound, rubber, natural or synthetic fabric or fiber(s), etc., flexible cables, and/or the like).

### Exemplary Non-Limiting Support Furniture

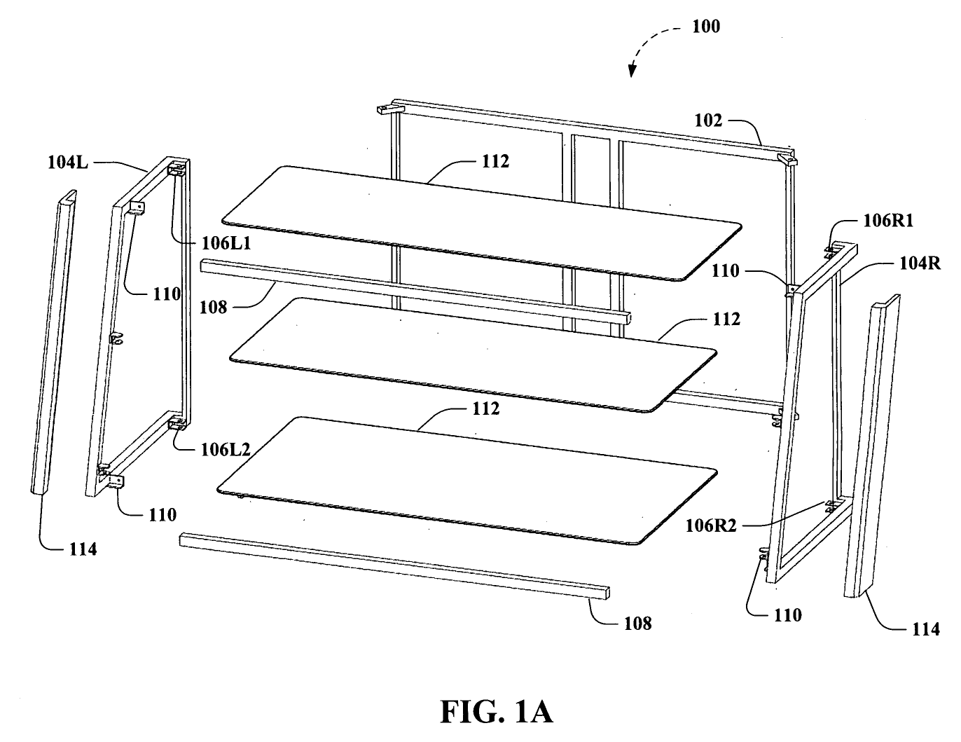

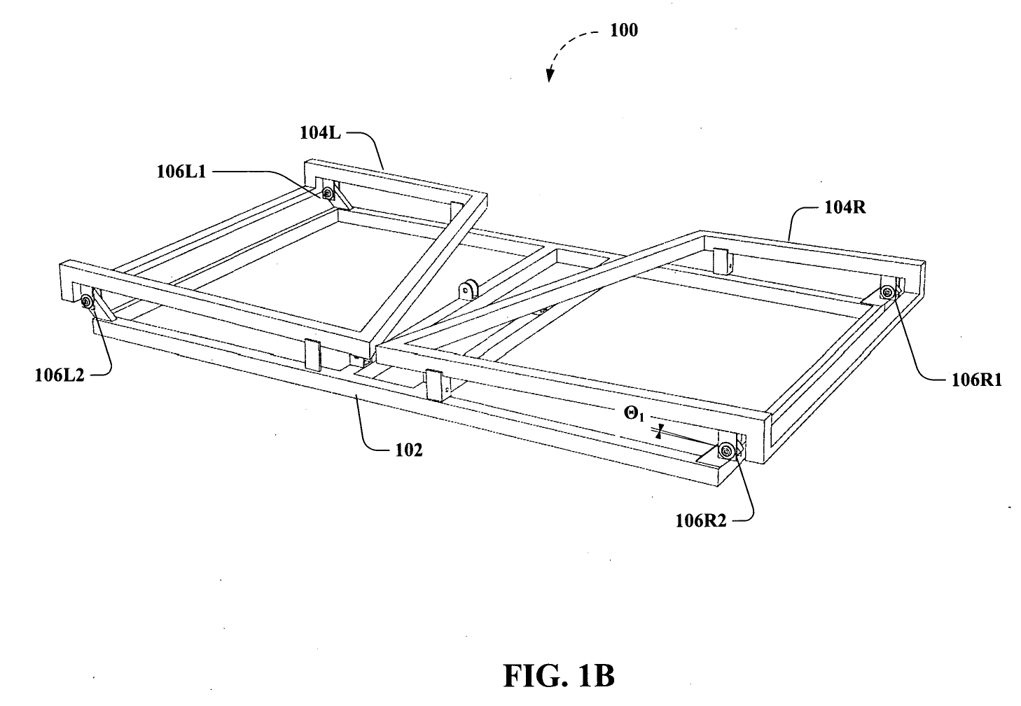

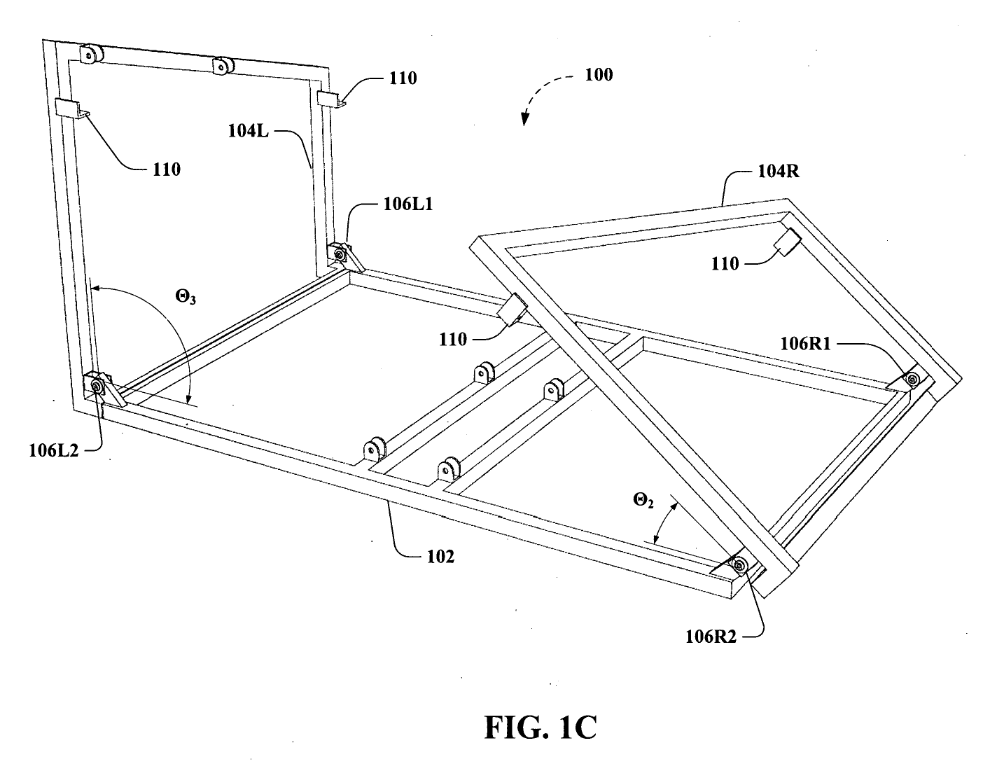

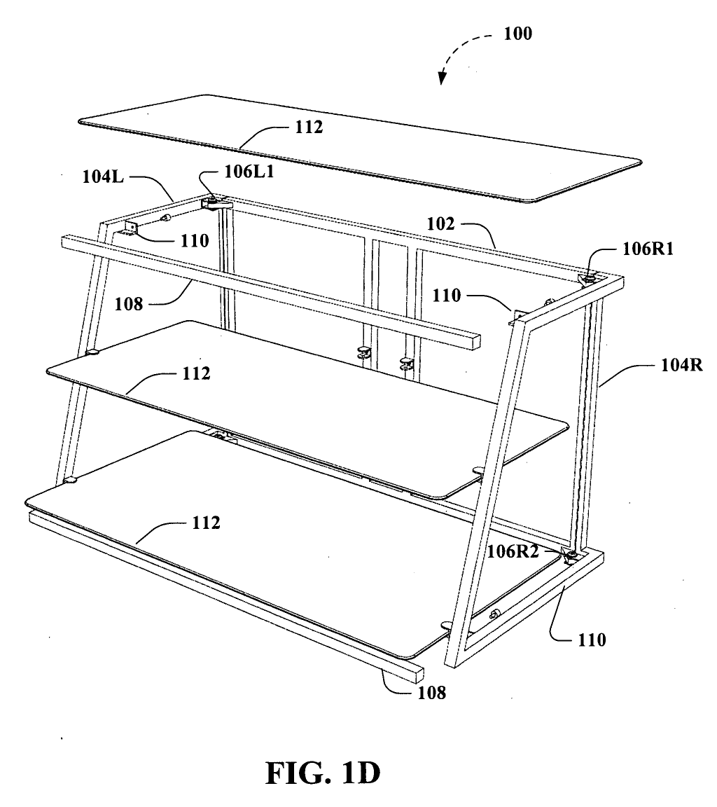

As described herein, various embodiments of the disclosed subject matter utilize the disclosed hinging apparatuses that can provide for novel support furniture systems. As shown in FIG. 1A, for instance, one of ordinary skill in the art can appreciate that there are a multitude of possible design options in the choice of furniture designs. The disclosed subject matter, however, provides many advantages over conventional designs through its novel hinging apparatus, structures, and support furniture systems facilitated thereby. Thus, while the components illustrated in the television stand 100 are shown for discussion purposes, the structures of the FIG. 1A and other figures are not intended to be limiting.

FIGS. 1A to 1D illustrate an exemplary non-limiting embodiment of support furniture systems in accordance with aspects of the disclosed subject matter, in which FIG. 1A illustrates an exploded view of component parts of an exemplary television stand 100. The exemplary television stand 100, in various non-limiting embodiments, can comprise a frame back 102 and two frame sides 104R and 104L (denoting a right frame side 104R and a left frame side 104L as viewed from the front). For illustrative purposes, the frame back 102 and two frame sides 104R and 104L of the exemplary embodiment are of welded steel construction. However, any suitable replacement construction is contemplated as within the scope of the disclosed subject matter.

The frame back 102 can be connected to the two frame sides 104R and 104L via respective hinging apparatuses 106 (106R1/2 and 106L1/2). For example, the connection of frame back 102 to right frame side 104R can be accomplished by at least hinging apparatuses 106 (e.g., either 106R1, 106R2, or both). The left frame side 104L can be connected to the frame back 102 in a similar manner. It should be understood that additional hinging apparatuses 106 can be used without departing from the scope of the disclosed subject matter.

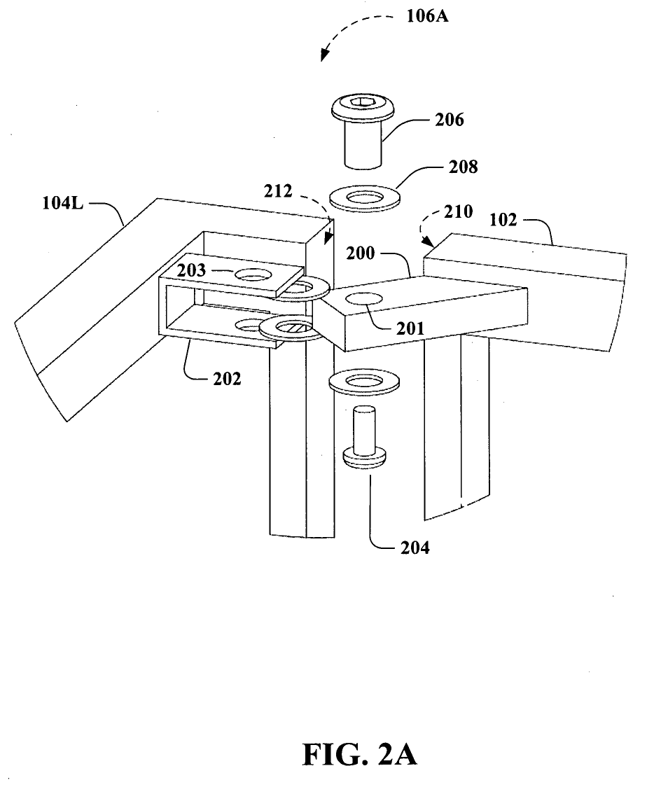

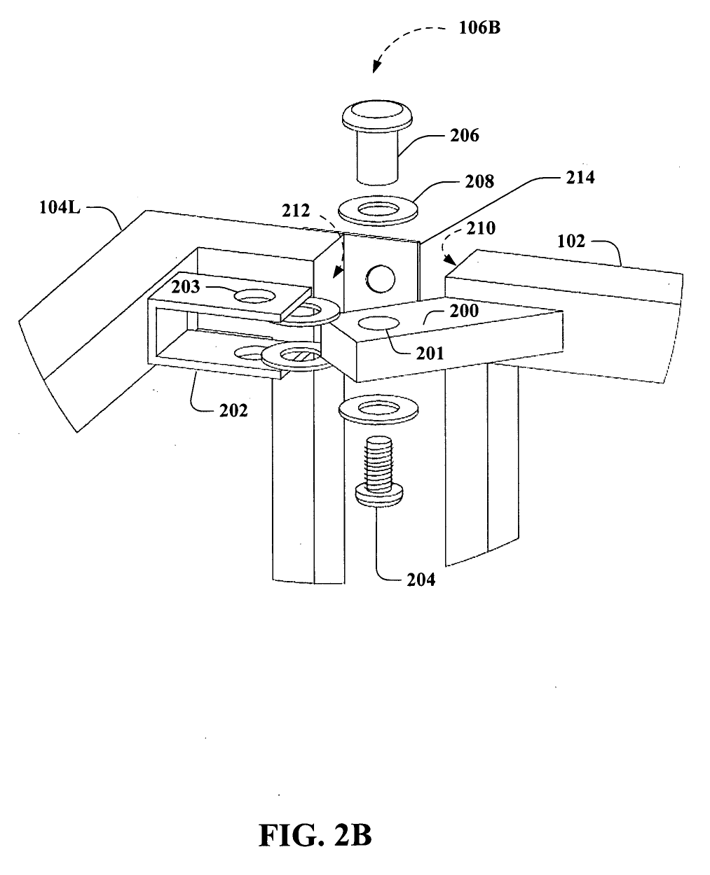

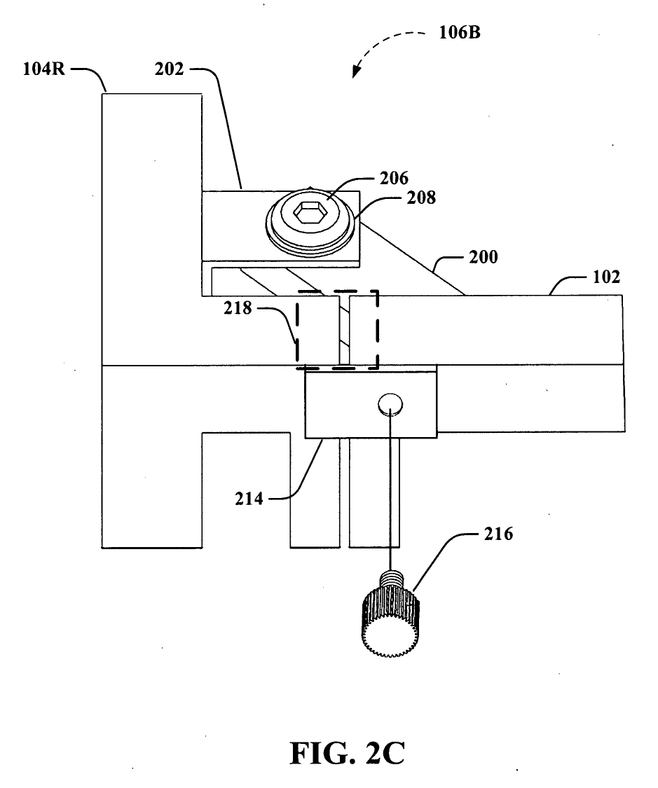

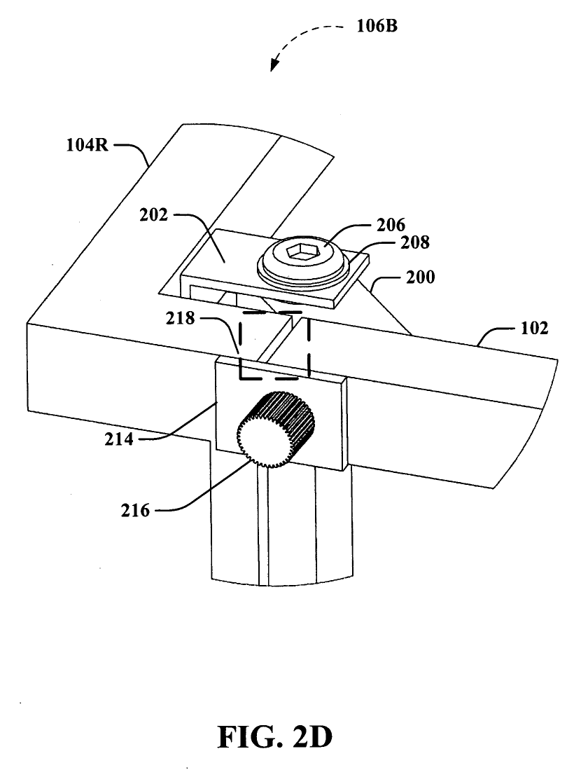

Hinging apparatuses 106 and associated variations are discussed in greater detail, for example, in conjunction with FIGS. 2A to 2D.

Frame sides 104R and 104L and hinging apparatuses 106 can be temporarily locked into assembled position, for example, by virtue of at least one locking cross-bar(s) 108 being located and affixed to frame sides 104R and 104L at suitable attachments points 110 located on frame sides 104R and 104L and facilitated with suitable removable attaching hardware (e.g., screws, thumbscrews, pins, detent and spring loaded ball, etc.) (not shown). The locking cross-bar 108 provides the advantages of fixing the hinging apparatus 106 rotation in the assembled position, which in turn facilitates keeping the two frame sides 104R and 104L into assembled position relative to the frame back 102 and each other.

For completeness, FIG. 1A also illustrates shelving 112 and fascia 114 of suitable material as desired for the particular application.

While the locking function in the form of at least one locking cross-bar(s) 108 is described for the present purposes, it should be understood that various embodiments of the disclosed subject matter can incorporate suitable alternative hinge apparatus locking structures. For example, it should be understood that shelving 112 could serve as a hinge apparatus locking mechanism, provided that the shelving 112 is suitably affixed at frame sides 104R and 104L and frame back 102 to provide the desired structural rigidity and load bearing capability. Additional alternative embodiments will be described in further detail below. It should be further noted that the temporary nature of the locking mechanism as described herein facilitates the advantage of easy disassembly of the support furniture system for efficient storage and ease of transport.

FIG. 1B illustrates structural components of the exemplary television stand 100 in a folded position suitable for efficient storage and ease of transport. FIG. 1C illustrates a range of motion of component parts provided by exemplary non-limiting embodiments of hinging apparatuses 106 during an exemplary assembly process. With reference to FIGS. 1B and 1C, the interior angles given by frame sides 104R and 104L with respect to frame back 102 are illustrated. For example, in a preferred embodiment of FIG. 1B, the interior angle given by frame side 104R with frame back 102 is denoted as θ₁ and is approximately equal to zero degrees (e.g., roughly parallel) in the event that television stand 100 is partially disassembled and folded, as would be appropriate in a storage or transport situation. As a further example, in a preferred embodiment of FIG. 1C, θ₂ (and θ₃) are illustrated to depict the interior angle given by frame side 104R(104L) with frame back 102. Note that for the present description, θ₂ is approximately equal to 90 (or 270) degrees (e.g., roughly orthogonal) and is roughly equivalent to the interior angle for the case where the television stand 100 is in the assembled condition. It should be appreciated that the angles noted for the θ₁ and θ₂ can be other than as noted for the preferred embodiment for the folded or assembled condition, provided that structural rigidity and load bearing capacity is maintained as desired.

FIG. 1D further illustrates the exemplary assembly process for the provided embodiment of the support furniture system, television stand 100.

Advantageously, hinging apparatuses 106, in conjunction with locking cross-bar 108, facilitate providing structural rigidity and load bearing capacity to the assembled support system embodied by television stand 100. For example, weight loads placed on top of shelf 112 or any other loads that would otherwise tend to cause distortion of the case formed by frame back 102, the two frame sides 104R and 104L, and locking cross-bar 108 would be stopped by the rigid hinging apparatus and the connections of the two frame sides 104R and 104L with the cross-bar 108 at attachments points 110. Thus, it should be understood that the disclosed subject matter advantageously provides a structurally rigid support furniture structure while simultaneously providing a compact form-factor that is conveniently stored and transported, for easy on-site assembly and disassembly.

### Exemplary Hinging Apparatuses and Structures

FIGS. 2A to 2C illustrate details of an exemplary non-limiting embodiment of a hinging apparatus in accordance with the disclosed subject matter. For instance, FIG. 2A illustrates an exploded view of component parts of an exemplary hinging apparatus 106A (e.g., 106L1/2), such as can be utilized in exemplary television stand 100. In this regard, hinge tabs 200 and 202 are rigidly attached (e.g., welded, spot-welded, brazed, riveted, attached with structural grade fasteners, etc.) to frame back 102 and frame side 104L respectively. Alternatively, or in conjunction with other methods, the hinge tabs 200 and 202 can be formed integral to the respective pieces (e.g., frame back 102 and frame sides 104) by a process suitable for providing the necessary structural integrity, such as by casting, forging, stamping, machining, and the like, or any combination thereof. According to various embodiments, hinge tabs 200 and 202 can include corresponding holes (e.g., 201 and 203) that align to accept a hinge pin assembly, although hinge tabs 200 and 202 can include other suitable arrangements designed to provide the hinging functionality while preserving structural rigidity.

Hinge pin assembly (204, 206, and 208) can comprise internally threaded hinge nut 206 that mates to externally threaded hinge bolt 204 (threads not shown). Hinge wear rings or washers 208 provide hinge wear bearing surfaces to facilitate ease of hinge apparatuses' 106 operation. In various non-limiting embodiments of the disclosed subject matter, the hinging apparatuses' 106 range of angular motion can be limited to the extent desired (e.g., approximately 90 (or 270) degrees, or substantially orthogonal in the preferred embodiment illustrated in FIG. 1) in the assembled position by surface 210 of frame back 102 engaging or nearly engaging surface 212 of frame side 104L (and likewise for the opposite side 104R).

FIG. 2B illustrates an exploded view of component parts of an exemplary hinging apparatus 106B with a locking tab 214 located proximate to the hinging apparatus 106B. In the present description, locking tab 214 can dispense with the need for locking cross-bar 108 (or can supplement the use of locking cross-bar 108) in further non-limiting embodiments of support furniture system. As an example, consider a desk system whereby use of locking cross-bar 108 would prevent comfortable seating with the end-users legs below the desk surface. In that instance, locking tab 214 provides the hinge locking function for structural rigidity while providing comfortable end-user seating and use of the furniture system.

FIGS. 2C and 2D depict views of exemplary hinging apparatus 106B in the process of being assembled with a locking tab 214 located proximate to the hinging apparatus 106B. In the exemplary non-limiting embodiment depicted, locking tab 214 locks frame side 104R position (e.g., at maximum swing of frame side 104 with respect to frame back 102) relative to frame back 102 (and hinge apparatus 106B angular position) through the use of a thumbscrew 216 that threads into frame back 102. As described above regarding method of fixation of locking cross-bar 108 to frame sides 104, the method of locking hinge apparatus 106B and locking tab 214 can be facilitated with suitable removable attaching hardware 216 (e.g., screws, thumbscrews, pins, detent and spring loaded ball, etc.) or non-removable hardware (e.g., clasps, latches, catches, spring-loaded or otherwise, and the like) without departing from the intended scope of the disclosed subject matter. Note that FIGS. 2C and 2D indicate the engagement (or near engagement) of surface 210 of frame back 102 engaging with surface 212 of frame side 104R as indicated by the boxed annotation 218.

### Further Non-Limiting Support Furniture

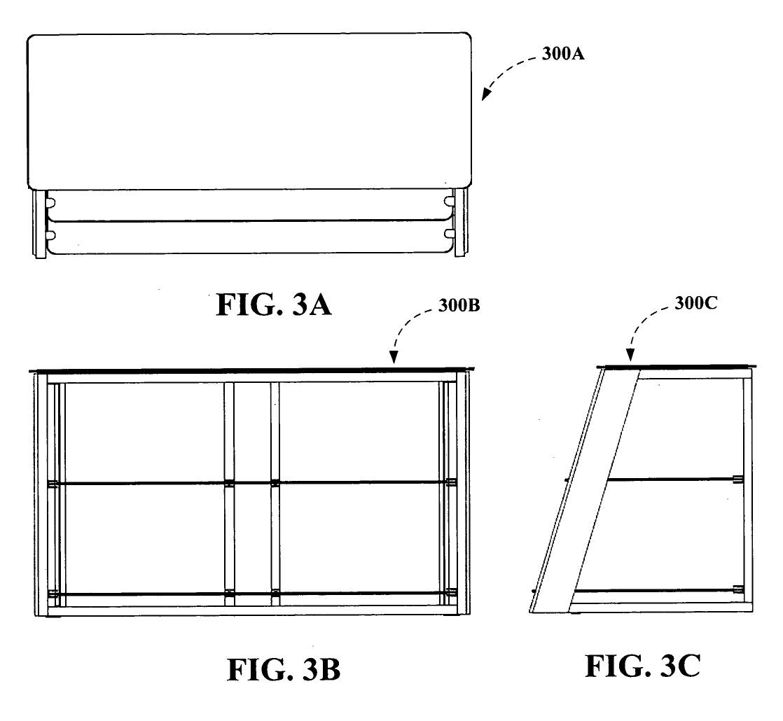

FIGS. 3A to 3C illustrate top, front, and side plan views of the exemplary non-limiting television stand 100 as shown in FIGS. 1A to 1D, which are provided as an aid in understanding further non-limiting embodiments of the disclosed subject matter.

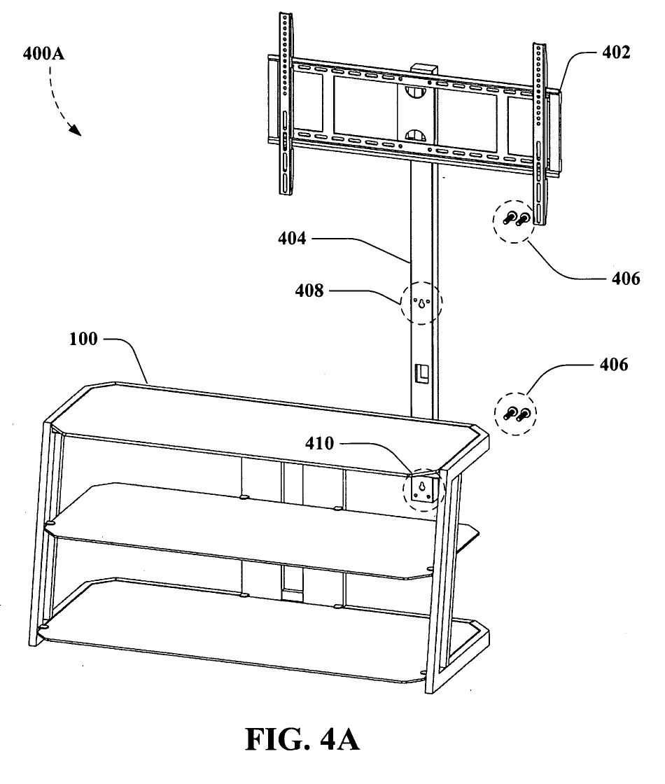

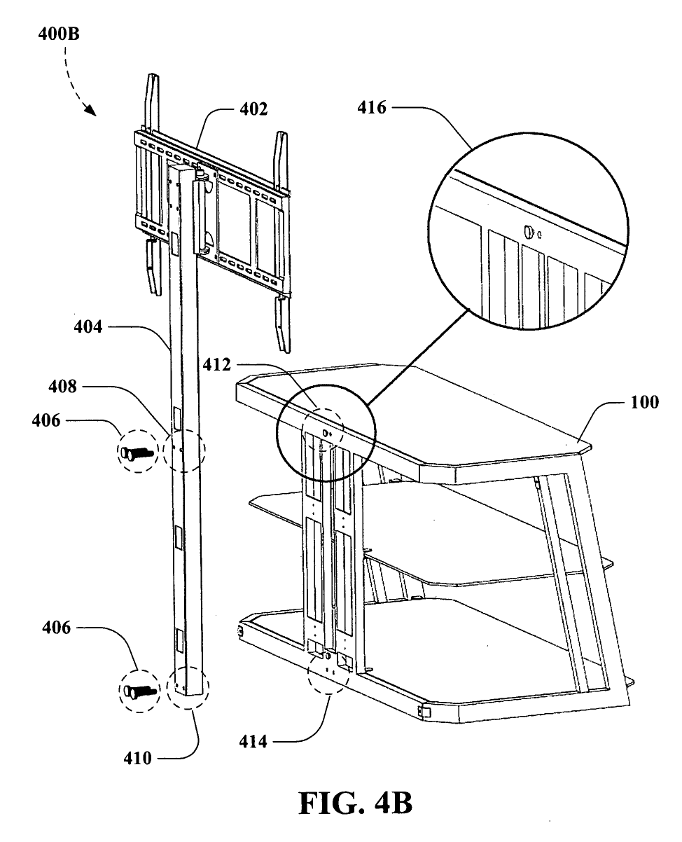

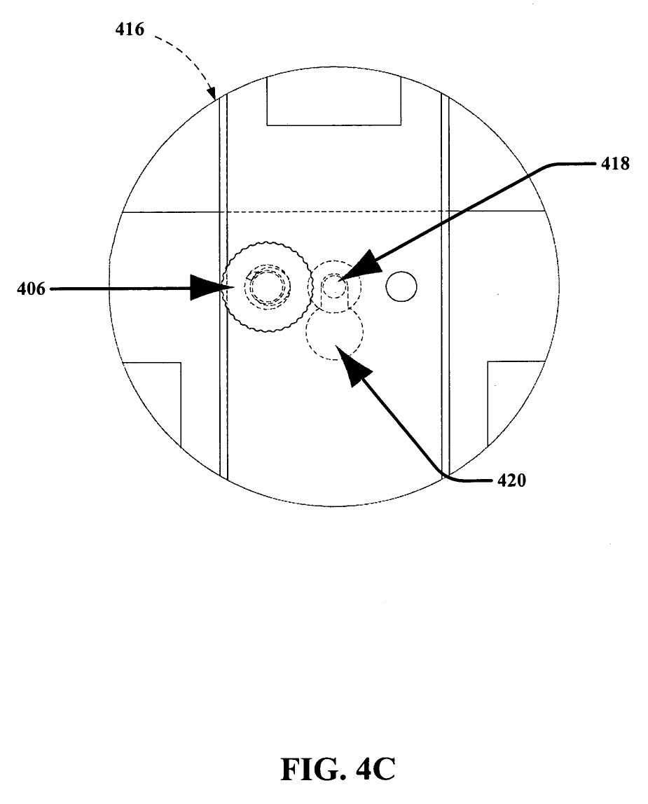

FIGS. 4A to 4C depict an exemplary non-limiting implementation of an integrated display bracket, which, when attached to a disclosed support furniture system such as exemplary television stand 100 shown in FIGS. 1A to 1D, can capitalize on the strength and durability provided by support furniture systems implemented in accordance with aspects of the disclosed subject matter. For example, typical LCD television sets can weigh 80 pounds or more. Coupled with a range of other media devices such as CD players, DVD players, amplifiers, game consoles, media center personal computers, set top boxes and the like, the weight of such an assembly of components can weigh over 100 pounds. As described above, support furniture systems such as television stand 100 are well suited to bearing the types of loads that can be expected in current and future home entertainment arrays. It should be appreciated that such strength and rigidity would be difficult to provide in conventional MDF based designs.

As depicted in FIG. 4A, a removable integrated display bracket 400A comprises a bracket head 402 for mounting a display and bracket post 404, which removably attaches to television stand 100 at frame back 102. Regarding FIGS. 4A and 4B, it can be seen that bracket post 404 can be removably attached to television stand 100 via thumbscrews 406 inserted through upper mounting holes 408 and lower mounting holes 410 on the bracket post 404. A display bracket attachment point comprised of corresponding threaded holes (412 and 414) on frame back 102, as shown in detail 416 and FIG. 4C, can be used in addition to, or in place of, a fixed post 418 on the frame back 102, which fixed post 418 can be inserted through a keyhole 420 in bracket post 404 (such as, for example, to provide temporary alignment of the bracket post 404 during assembly). As can be understood, the removable attachment to television stand 100 further allows easy disassembly for efficient storage and ease of transport, while advantageously providing the structural rigidity and load bearing capability provided by the disclosed subject matter.

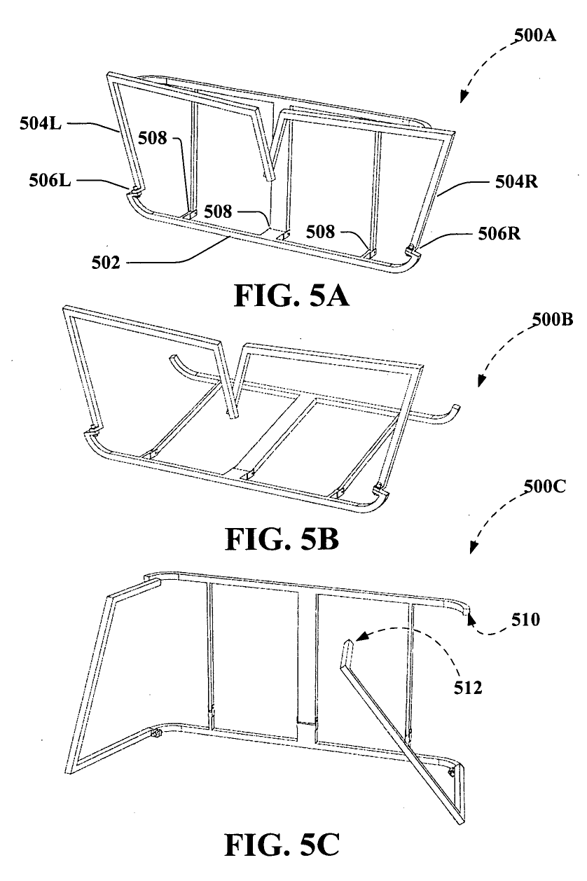

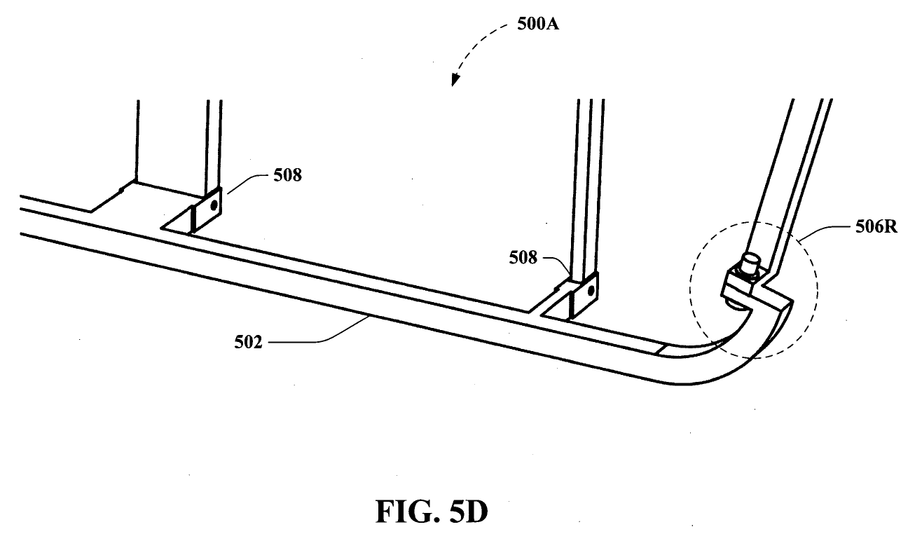

FIGS. 5A to 5D illustrate a further non-limiting implementation of support furniture systems that shows the richness of designs options that can be implemented in accordance with aspects of the disclosed subject matter, where similar numbering is shown for similar components for comparison with FIG. 1. For example, FIG. 5A illustrates a folded configuration 500A, and FIGS. 5B to 5C illustrate further assembly steps of the exemplary non-limiting implementation (500B and 500C). Note in FIG. 5D, that in addition to hinges connecting back frame 502 with side frames 504R and 504L, back frame 502 has additional hinge apparatuses 508 (e.g., only two of three hinge apparatuses 508 in this exemplary implementation are shown in FIG. 5D) in order to provide the compact storage and transport configuration for this implementation. Also note that in FIG. 5C, the hinge apparatus locking mechanism can be a locking cross-bar (e.g., a locking cross-bar 108), a locking tab (e.g., a locking tab 214) proximate to hinging apparatus 506, or can be provided by similar means at the engagement points 510 and 512 of frame back 502 and 504R respectively (and likewise for left frame side 504L and frame back 502).

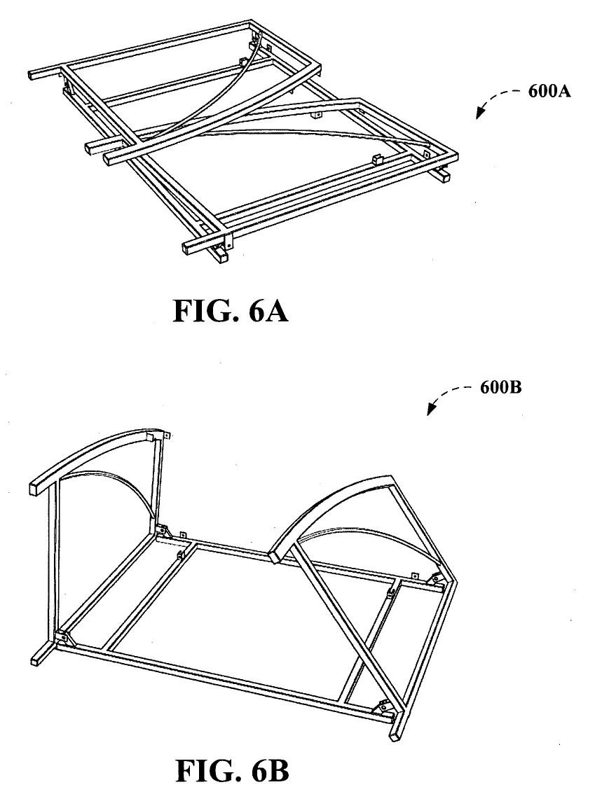

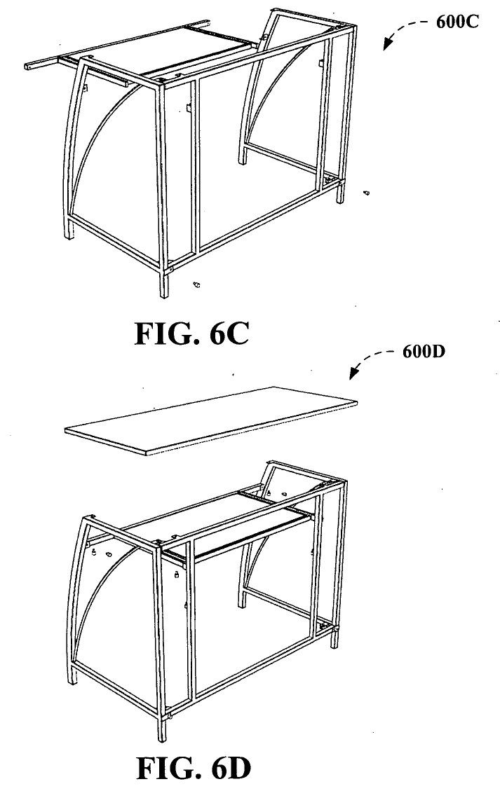

FIGS. 6A to 6D illustrate a further non-limiting embodiment of a support furniture system (e.g., a desk) in accordance with aspects of the disclosed subject matter, in which FIG. 6A illustrates a folded configuration, and FIGS. 6B to 6D illustrate further assembly steps of the implementation. Note that configuration 600D uses one locking cross-bar, as previously described and a desktop (which may or may not provide locking functionality as desired), as opposed to two locking cross-bars 108 as illustrated for the exemplary television stand 100. It should be appreciated that the configuration as illustrated in 600D could be used with a locking tab 214 located proximate to the hinging apparatus 106B as described above with reference to FIG. 2.

Thus, according to various non-limiting embodiments, the disclosed subject matter provides support furniture systems (e.g., such as television stand 100, support furniture system 500 or 600, etc.). For example, exemplary embodiments can include a back frame 102 (or 502) and a first and second side frame (e.g., frame sides 104R and 104L, 504R and 504L of embodiments of FIG. 5, or as illustrated in embodiments of FIG. 6). According to an aspect of the exemplary embodiments, the side frames can be attachable to the back frame each using a hinging apparatus (e.g., hinging apparatus 106, 106A, 106B, 506, etc.).

According to a further aspect, the first and second side frames can have an engagement surface (e.g., a surface on each of the first and second side frames, for example frame back 102 (or 502, for example) and frame side 104R or 104L, which engagement surface can be located proximate to the hinging apparatus such as in surfaces 212, or a second set of engagement surfaces can be located elsewhere on the respective side frames, such as in surfaces 512). Such engagement surfaces can correspond to a respective engagement surface on the back frame 102 (e.g., surfaces 210 or 510) that can restrict maximum angular motion of the first and second side frames relative to the back frame 102.

Another aspect of the exemplary embodiments can include a removable hinge apparatus lock assembly (for example, a fixed lock tab (e.g., locking tab 214), a removable lock bar or locking bar (e.g., locking cross-bar 108) in conjunction with designated points of attachment, such as attachment points 110, on frame side 104R or 104L, a shelf or top surface 112 suitably attached (e.g., at designated points selected to prevent frame racking, twisting, or collapse) to frame sides 104 and frame back 102, etc.). The removable hinge apparatus lock assembly can prevent the first and second side frames from swinging toward the back frame, when properly attached, for example, during assembly and for the duration that the support furniture system is desired to remain assembled.

According to further non-limiting embodiments, the disclosed subject matter provides a hinging apparatus for a load bearing frame assembly (e.g., a support furniture system such as television stand 100, support furniture system 500 or 600, etc.). An aspect of the hinging apparatus can include first and second hinge tabs (e.g., hinge tabs 200 and 202) attached to first and second frame pieces respectively (e.g., frame back 102 or 502 and frame side 104R or 104L(or 504R)) of the load bearing frame assembly and having a first and second hinge pin holes (e.g., 201 or 203).

A further aspect of the hinging apparatus can include a hinge pin (e.g., portions of hinge pin assembly 204 and 206, or suitable substitutes therefor, for example) inserted through the first and second hinge pin holes to hold the first and second frame pieces together and that allows the first and second frame pieces to swing relative to each other. The first and second frame pieces can further include a set of engagement surfaces (e.g., a surface on each of the first and second frame pieces, for example frame back 102 (502) and frame side 104R or 104L (or 504), which can be located proximate to the hinging apparatus such as in surfaces 210 and 212, or a second set of engagement surfaces can be located elsewhere on the respective side frames, such as in surfaces 510 and 5 12). Such engagement surfaces can limit the maximum swing of the second frame piece relative to the first frame piece, such as for example, when the engagement surfaces engage or are nearly engaged.

Yet another aspect of the exemplary hinging apparatus can include a temporary locking mechanism (for example, a fixed lock tab (e.g., locking tab 214), a removable lock bar or locking bar (e.g., locking cross-bar 108) in conjunction with designated points of attachment, such as attachment points 110, on frame side 104R or 104L, a shelf or top surface 112 suitably attached (e.g., at designated points selected to prevent frame racking, twisting, or collapse) to frame sides 104 and frame back 102, etc.). The temporary locking mechanism, when engaged, can prevent the second frame piece from swinging toward the first frame piece.

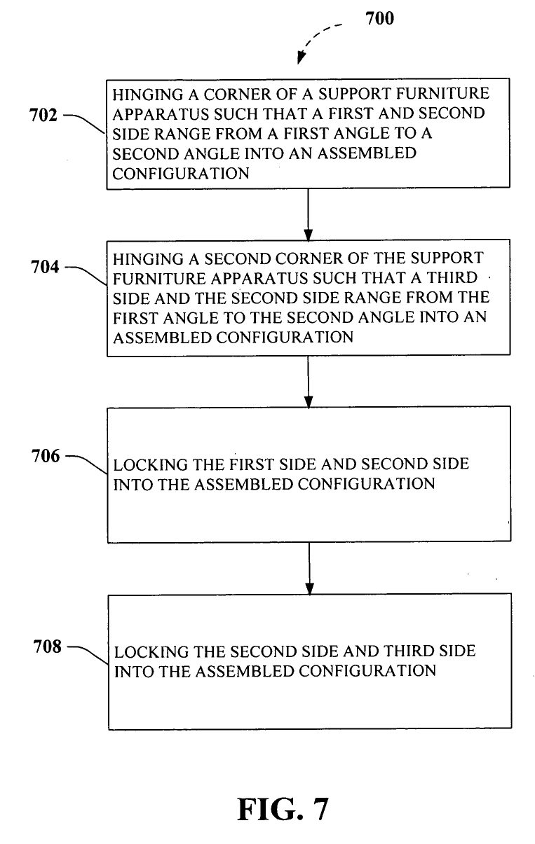

In view of the exemplary apparatuses and systems described supra, methodologies that can be implemented in accordance with the disclosed subject matter will be better appreciated with reference to the flowchart of FIG. 7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Any non-sequential, or branched, flow illustrated via a flowchart should be understood to indicate that various other branches, flow paths, and orders of the blocks, can be implemented which achieve the same or a similar result. Moreover, not all illustrated blocks may be required to implement the methodologies described hereinafter.

### Exemplary Assembly Methodologies

FIG. 7 depicts exemplary non-limiting methodologies for assembling a support furniture system (e.g., a television stand 100) in accordance with aspects of the disclosed subject matter. As can be appreciated, the assembly methodologies derive many benefits from the novel aspects of the disclosed subject matter.

For instance, at 702 a corner of a support furniture apparatus can be hinged (e.g., via hinging apparatus 106, 106A, 106B, 506, etc.) such that a first side (e.g., 104R or 104L) and a second side 102 of the support furniture apparatus (e.g., television stand 100) can range from a first angle θ₁ (e.g., storage or transport configuration) to a second angle θ₂ (e.g., respective assembled configuration) based on the hinging and thereby creating an assembled configuration with respect to the first (e.g., 104R or 104L) and second (102) sides.

Likewise, at 704, a second corner of a support furniture apparatus can be hinged (e.g., via hinging apparatus 106, 106A, 106B, 506, etc.) such that a third side (e.g., another of 104L or 104R) and the second side 102 of the support furniture apparatus (e.g., television stand 100) can range from the first angle θ₁ (e.g., storage or transport configuration) to a second angle θ₂ (e.g., respective assembled configuration) based on the hinging and thereby creating an assembled configuration with respect to the third (e.g., another of 104L or 104R) and second (102) sides. In a preferred embodiment, the sides (e.g., 102 and 104) can range from approximately zero or 180 degrees (or roughly parallel) to roughly 90 (or 270) degrees (or roughly orthogonal).

Additionally, at 706, the first (e.g., 104R or 104L) and second (102) sides can be locked into the assembled configuration. As described above with reference to FIGS. 1, 2, and 5, the respective sides can be locked into assembled position, for example, according to the descriptions regarding the locking cross-bar 108 and attachment points 110, locking tab 214 and fastener 216, or engagement points located at locations 510 and 512. In further non-limiting embodiments of methodologies 700, shelves or top surfaces can be fastened to attachment points on sides 102 and 104 in order to lock the sides in the respective assembled configuration (not shown).

Likewise for the first and second sides, at 708, the third side (e.g., another of 104L or 104R) and the second side 102 can be locked into their respective assembled configuration. As described above, the second and third sides can be locked into assembled configuration as describe above with reference to FIGS. 1, 2, and 5 and step 706 of methodologies 700.

In addition, methodologies 700 can include extending the hinging to a maximum hinging range allowed (e.g., by corresponding engagement surfaces 210 and 212, or 510 and 512, or similar means) prior to locking the first (e.g., 104R or 104L) and second side 102 into the assembled configuration (not shown).

While the disclosed subject matter has been described in connection with the preferred embodiments of the various Figures, it is to be understood that other similar embodiments may be used or modifications and additions may be made to the described embodiment for performing the same function of the disclosed subject matter without deviating therefrom. For example, one skilled in the art will recognize that aspects of the disclosed subject matter as described in the present application may apply to any type of support furniture structure using a load bearing hinging apparatus. For instance, such hinging mechanisms can be applied in other applications requiring efficient storage and ease of transport, while providing improved durability and good load bearing capability. In any case, the structures and systems described herein have many applications in the support furniture market. Therefore, the disclosed subject matter should not be limited to any single embodiment described herein, but rather should be construed in breadth and scope in accordance with the appended claims.

What is claimed is:

1. A hinging apparatus for a load bearing frame assembly, comprising:
a first hinge tab attached to a first frame piece of the load bearing frame assembly and having a first hinge pin hole;
a second hinge tab attached to a second frame piece of the load bearing frame assembly and having a second hinge pin hole;
a hinge pin inserted through the first and second hinge pin holes in the respective first and second hinge tabs that holds the first and second frame pieces together and that allows the first and second frame pieces to swing relative to each other;
a first set of corresponding engagement surfaces of the first and second frame pieces that, when engaged, limits a maximum swing of the second frame piece relative to the first frame piece; and
a temporary locking mechanism between the first and second frame pieces that, when engaged, prevents the second frame piece from swinging toward the first frame piece.

2. The hinging apparatus of claim 1, the temporary locking mechanism comprises a locking tab attached to one of the first and second frame pieces and located proximate to the location of the first and second hinge tabs.

3. The locking tab of claim 2, wherein the locking tab includes a hole that aligns at maximum swing with a corresponding hole on the other of the one of the first and second frame pieces, which corresponding hole accepts a fastener to allow the first and second frame pieces to be fastened temporarily.

4. The hinging apparatus of claim 1, the temporary locking mechanism comprises a fastener temporarily fastened at a second set of corresponding engagement surfaces of the first and second frame pieces, the second corresponding engagement surfaces are formed as the first and second frame pieces rotate about an axis of the hinging apparatus.

5. The hinging apparatus of claim 1, the temporary locking mechanism comprises a removable locking bar that, when attached to attachment points on the second frame piece and a third frame piece that is attached to the first frame piece, temporarily prevents the second frame piece from swinging toward the first frame piece.

6. A support furniture system, comprising:
a back frame;
a first and second side frame attachable to the back frame each using a hinging apparatus, the first and second side frames each having an engagement surface that corresponds to a respective engagement surface on the back frame that restricts maximum angular motion of the first and second side frames relative to the back frame; and
a removable hinge apparatus lock assembly that when attached to the support furniture system, prevents at least one of the first and second side frames from swinging toward the back frame.

7. The support furniture system of claim 6, the removable hinge apparatus lock assembly comprises a removable lock bar that fastens to designated points on the first and second side frames.

8. The support furniture system of claim 6, the removable hinge apparatus lock assembly comprises a fixed lock tab that is located on either the back frame or one of the first and second side frames, holes in the lock tab and a corresponding one of the first and second side frames align for fastening the back frame to one of the first and second side frames.

9. The support furniture system of claim 6, the removable hinge apparatus lock assembly comprises at least one of a shelf and a top surface, the at least one of a shelf and a top surface fastens to designated points on the first and second side frames and the back frame.

10. The support furniture system of claim 9, further comprising the top surface wherein the top surface is attached to one of the first and second side frames or the back frame by a hinge.

11. The support furniture system of claim 6, further comprising a display bracket attachment point located on the back frame for attaching a removable integrated display bracket.

12. The support furniture system of claim 11, further comprising the removable integrated display bracket.

13. A method for assembling a support furniture apparatus comprising:
hinging a corner of the support furniture apparatus such that a first side and a second side of the support furniture apparatus range from a first angle to a second angle based on the hinging and thereby creating an assembled configuration with respect to the first and second sides; and
locking the first side and second side into the assembled configuration.

14. The method of claim 13, further comprising extending the hinging to a maximum hinging range allowed prior to locking the first and second side into the assembled configuration.

15. The method of claim 13, the hinging includes hinging a corner of the support furniture apparatus such that a first side and a second side of the support furniture apparatus range from being in substantially parallel planes to being in substantially orthogonal planes.

16. The method of claim 13, the locking includes temporarily fastening the first side to the second side using a fastener.

17. The method of claim 13, the locking the first side and second side into assembled configuration includes attaching at least one of a shelf and a top surface to attachment points on the first and second sides.

18. The method of claim 13, further comprising attaching a removable electronic display bracket to the second side.

19. The method of claim 13, further comprising hinging a second corner of the support furniture apparatus such that a third side and the second side of the support furniture apparatus range from the first angle to the second angle based on the hinging and thereby creating an assembled configuration with respect to the second and third sides.

20. The method of claim 19, the locking the first side and second side into assembled configuration includes attaching the third side to the first side by attaching a locking cross-bar to respective attachment points on the first and third sides, thereby locking the first and second sides and second and third sides into their respective assembled configurations.
